(19) United States
(12) Patent Application Publication
(10) Pub. No.: US 2014/0324526 A1
(43) Pub. Date: Oct. 30, 2014

(54) CAPTURING VIEWER INFORMATION FROM MULTIPLE PAGES OF A CAREER SITE

(71) Applicant: Linkedln Corporation, Mountain View, CA (US)

(72) Inventors: Prashanth Govindarajan, San Jose, CA (US); Qi Liu, Saratoga, CA (US); Kai Wei, Belmont, CA (US)

(21) Appl. No.: 13/907,720

(22) Filed: May 31, 2013

Related U.S. Application Data
(60) Provisional application No. 61/817,524, filed on Apr. 30, 2013.

(51) Int. Cl. G06Q 30/02

(52) U.S. Cl. CPC G06Q 30/0201
USPC 705/7.29

(57) ABSTRACT

Methods and systems for capturing viewership information from multiple pages of a career site are described. In some example embodiments, the methods and systems access first information captured by a first javascript beacon located at a job listing page of a career site, access second information captured by a second javascript beacon located at one or more job application pages of the career site, compare the first information to the second information, and present viewership information for the career site based on the comparison.

### CROSS-REFERENCE TO RELATED APPLICATIONS

This application claims priority to U.S. Provisional Patent Application No. 61/817,524, filed on Apr. 30, 2013, entitled CAPTURING VIEWER INFORMATION FROM MULTIPLE PAGES OF A CAREER SITE, which is hereby incorporated by reference in its entirety.

### TECHNICAL FIELD

The present disclosure generally relates to information retrieval and analytics. More specifically, the present disclosure relates to methods, systems and computer program products for using social network information in analyzing career site viewers information.

### BACKGROUND

There are many different ways to apply for a job. A candidate may mail or email a cover letter and resume to a company looking to fill a position, may visit a job fair and fill out an application, and/or may submit application materials via a website configured to display available job listings and receive submissions from prospective candidates, among other ways. Currently, many companies require applicants to submit materials electronically, via one or more systems associated with the companies.

For example, many companies utilize an applicant tracking system (ATS) that manages data operations associated with posting job listings, recruiting applicants for available jobs, receiving applications, storing resume and other applicant data, and so on. An ATS, therefore, may act as a centralized system that provides various automated workflows to handle some or all aspects of the job recruitment process, among other things.

### DESCRIPTION OF THE DRAWINGS

Some embodiments of the technology are illustrated by way of example and not limitation in the figures of the accompanying drawings.

FIG. 1 is a block diagram illustrating an example of a network environment including a server operating a system for using social network information in analyzing career site viewership, consistent with some embodiments.

FIG. 2 is a block diagram illustrating modules of a career site analytics system, consistent with some embodiments.

FIG. 3 is a block diagram illustrating data flow operations between a career site, a social network service, and the career site analytics system, consistent with some embodiments.

FIG. 4 is a flow diagram illustrating a method for presenting viewership information associated with viewers of a career site, consistent with some embodiments.

FIGS. 5A-5B are display diagrams illustrating the presentation of viewership information for a career site, consistent with some embodiments.

FIG. 6 is a block diagram illustrating data flow operations between various pages of a career site and the career site analytics system, consistent with some embodiments.

FIG. 7 is a flow diagram illustrating a method for presenting viewership information for various pages of a career site, consistent with some embodiments.

FIG. 8 is a display diagram illustrating the presentation of viewership information for various pages of a career site, consistent with some embodiments.

FIG. 9 is a block diagram illustrating data flow operations between a information capture beacon and one or more tracking pixels within a career site, consistent with some embodiments.

FIG. 10 is a flow diagram illustrating a method for providing information associated with viewership of various pages of a career site, consistent with some embodiments.

FIG. 11 is a block diagram of a machine in the form of a computing device within which a set of instructions, for causing the machine to perform any one or more of the methodologies discussed herein, may be executed.

### DETAILED DESCRIPTION

### Overview

The present disclosure describes methods, systems, and computer program products, which individually provide functionality for using social network information in analyzing career site viewership.

In some example embodiments, the method and systems access information associated with multiple viewing sessions of job listings presented at a career site, determine users associated with the multiple viewing sessions are members of a social network service, access profile information for users that are members of the social network service, and present information identifying characteristics of the users associated with the multiple user viewing sessions based on accessed profile information.

For example, the methods and systems may access information captured by a javascript beacon located at a job listing page provided by a career site, the information associated with user viewership of the job listing page provided by the career site, identify one or more referral sites that referred users to the career site based on the accessed information, and present information comparing the identified one or more referral sites.

In some example embodiments, the methods and systems access first information captured by a first javascript beacon located at a job listing page of a career site, access second information captured by a second javascript beacon located at one or more job application pages of the career site, compare the first information to the second information, and present viewership information for the career site based on the comparison.

In some example embodiments, the methods and systems capture, via a beacon at a job listing page, information identifying a viewer of the job listing page and information identifying a referring site for the viewer, capture, via the beacon at the job listing page, information from a tracking pixel located at a job application page, the information indicating the viewer has viewed the job application page, and provide the captured information to an analytics server.

Thus, in some example embodiments, the method and systems described herein provide a company with information identifying the types of viewers, the referring sites, and other information associated with a career site used to recruit hob applicants to the company, among other things.

In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

Other advantages and aspects of the inventive subject matter will be readily apparent from the description of the figures that follows.

### Suitable System

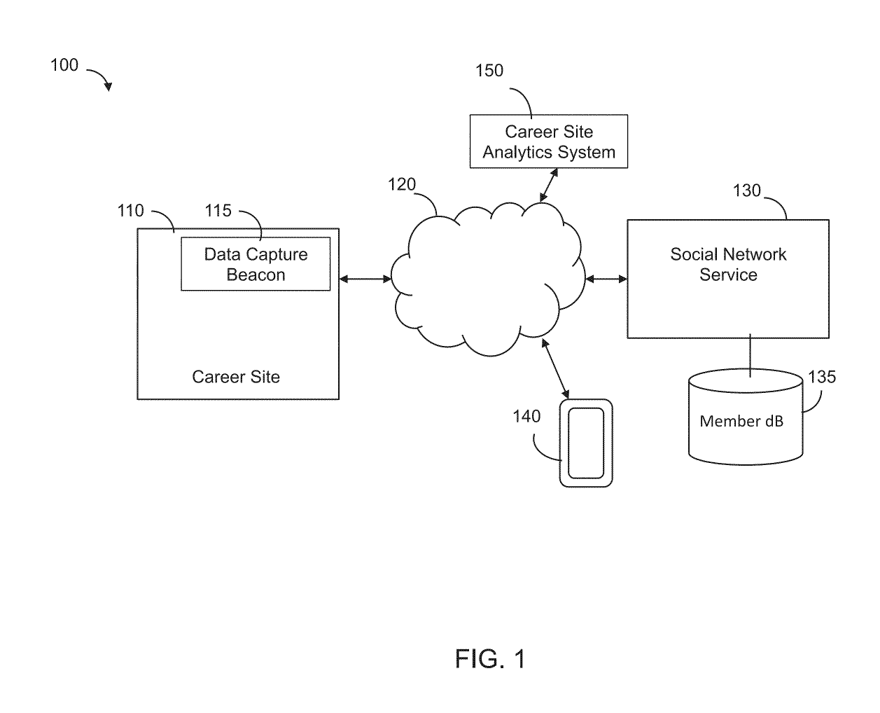

FIG. 1 is a block diagram illustrating an example of a network environment 100 including a server operating a system for using social network information in analyzing career site viewership, consistent with some embodiments. The network environment 100 includes a career site 110, such as an applicant tracking system (ATS), e.g., Jobvite, Taleo, Konexa, and so on, which manages data operations associated with posting job listings, recruiting applicants for available jobs, receiving applications, storing resume and other applicant data, and so on. The career site 110 may be hosted by or interact with a company's employment website in order to facilitate the display of job listing pages, which may include one or more job listings, the display of job application pages, which may include user-selectable elements configured to receive electronic information (e.g., resumes, cover letters, text entry, and so on) from a user during receipt of a job application from the user.

In some example embodiments, a user or viewer (e.g., a job searcher or job applicant) may access and/or view web pages provided by the career site 110 via a user device 140, which may be any suitable computing device, such as a smart phone, a tablet, a laptop, a gaming device, and/or any mobile device or computing device configured to display job listings, receive application information, and so on.

The career site 110 may include and/or contain an information capture element, such as a javascript beacon or script 115, which is configured to detect and capture information associated with various viewing events for web pages displayed and/or presented by the career site 110. The beacon 115 may provide information over a network 120 to a career site analytics system 150, which may also receive and/or other access information from a social network service 130, such as member profile information contained in a member database 135 and associated with members of the social network service 130.

A social network service 130 is a useful location in which to obtain various types of information associated with a job candidate, job applicant and/or viewer of a job listings page. Often, a social network or other similar site, such as LinkedIn, Facebook, Google+, Twitter, and so on, stores various types of information associated with members of the site. For example, a friend-based social networking site may store interest information for a member (e.g., information about things a member “likes”), whereas a business-based social networking site may store accomplishment or experience information for a member (e.g., educational or work experience information). Additionally, the social network service 130 may store a variety of information associated with a member's social graph, such as information identifying other members within the member's social graph.

In various example embodiments, one or more portions of the network 120 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, any other type of network, or a combination of two or more such networks.

By way of example, a user may use a web browser or application supported by his/her user device 140 to access a website (e.g., LinkedIn, Indeed, and job listing services or listing aggregators) that includes job listings for jobs available at various different entities. Upon receiving a selection from the user of one of the listings, the web browser may navigate from the website (e.g., the referring or referral site) to the career site 110 that manages recruitment associated with the company providing the selected job listing. The user may enter the career site 110 at an entry page, such as a page that presents information for the job listing, and should the user wish to submit an application for the job, the career site 110 may present a job application page to facilitate the reception of application materials from the user. The user may then exit the career site 110 after submitting application materials via the job application page (or, optionally, after seeing a page that displays a message confirming receipt of the application materials).

The beacon 115 may capture various information associated with interactions between the user and pages provided by the career site 110, such as information identifying the user (e.g., a member identifier associated with the user's membership with the social network service 130), information identifying the user device 140 (e.g., an IP address or device identifier for the device) information associated with the referring site (e.g., the referring sites URL), information associated with pages viewed by the user (e.g., URLs for various pages presented by the career site 110), information associated with a time period during which the user accessed the career site 110, and so on.

The beacon may transit, communicate, and/or otherwise provide the captured information over the network 120 to the career site analytics system 150. The career site analytics system 150 may access the information, and use the information, such as a member ID, to access information associated with the user from the social network service 130, such as member profile information. Thus, the career site analytics system 150, for a given user, may track and/or capture information associated with a referring site from which the user accessed the career site 110, information associated with the pages viewed by the user within the career site 110, and/or information associated with the user, such as biographical or demographic information (e.g., work experience, education experience, industry, and o on) received from the social network service 130, among other things.

The career site analytics system 150 may capture and/or determine such information for multiple users (e.g. some or many users) of a career site 110, and generate and/or publish reports and other presentable information (e.g., analytics, graphs, ranked lists, metrics, and so on).

Thus, the systems and methods described herein, may, in some example embodiments, enable a career site analytics system 150 to track and/or capture viewer information at a career site 110, match the information to information provided by a social network service 130 to identify types of users that view the career site 110, and perform various actions associated with reporting and/or presenting information that reflects various aspects of viewership of the career site 110, among other things. Such information may enable a company to receive and/or utilize various metrics and/or analysis provided by the career site analytics system 150 when determining what referring sites should be used when posting job listings, what job listings are effective in recruiting certain types of applications, and so on.

### Examples of the Career Site Analytics System

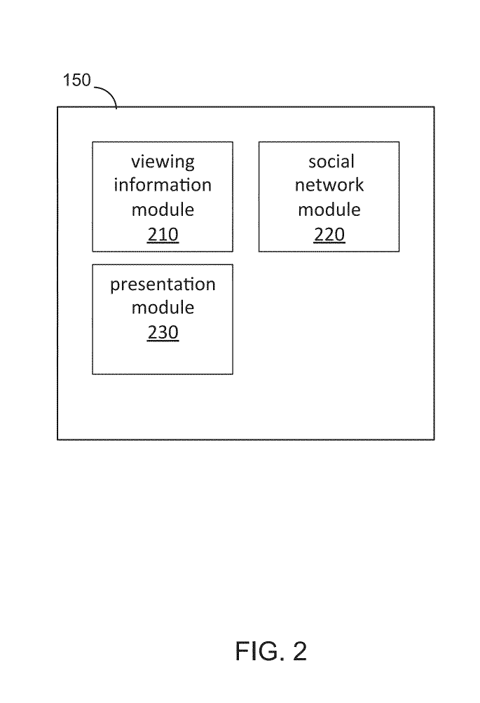

As described herein, in some example embodiments, the career site analytics system 150 may access viewership information associated with viewers at a career site (e.g., career site 110), determine the viewers are members of a social network service (e.g., social network service 130), and perform actions using the viewership information and member profile information from the social network service in order to generate reports and other displays of information for the career site, among other things. FIG. 2 is a block diagram illustrating modules of the career site analytics system 150, consistent with some embodiments.

As illustrated in FIG. 2, the career site analytics system 150 includes a variety of functional modules. One skilled in the art will appreciate that the functional modules are implemented with a combination of software (e.g., executable instructions, or computer code) and hardware (e.g., at least a memory and processor). Accordingly, as used herein, in some embodiments a module is a processor-implemented module and represents a computing device having a processor that is at least temporarily configured and/or programmed by executable instructions stored in memory to perform one or more of the particular functions that are described herein.

Referring to FIG. 2, the career site analytics system 150 includes a viewing information module 210, a social network module 220, a presentation module 230, and other modules not shown in the Figure.

In some example embodiments, the viewing information module 210 is configured and/or programmed to access information associated with multiple viewing sessions of job listings presented at a career site. For example, the viewing information module 210 may access information captured by the javascript beacon 115 located at a page provided by and/or supported by the career site 110 (e.g., supported by an ATS), such as a job listing page that includes job listings presented at the career site 110 or a job application page configured to facilitate applications for jobs by viewers of the career site 110.

As described herein, the beacon 115 may capture various types of information associated with the viewing of pages provided by the career site 110, such as:

Information associated with referral sites that referred the users to the career site and information associated with one or more job listings viewed by the users, such as a URL (or information contained in the URL) for the referring site, information extracted from contents of pages of the referral site, and so on;

Information associated with referral sites that referred the users to the career site and information associated with a time period in which the users viewed the job listings;

Information associated with a page provided by the career site at which the users entered the career site;

Information associated with an exit page provided by the career site from which the users exited the career site;

Information identifying the user as a member of the social network service 130, such as a member ID (e.g., username, email address, and so on) for the social network service 130, a device ID (e.g., IP address or unique device ID) associated with the user device 140 used to access the career site 110 (which may match information stored in the social network service 130); and so on.

As described herein, the career site analytics system 150 may provide, utilize, and/or receive information from a beacon or script 115 installed and/or supported by the career site 110. The beacon or script 115, which may be implemented in javascript or other scripting protocols, may track the viewing and/or other interactions between users of the career site 110 and pages provided by the career site 110.

An example beacon 115, which may be a hidden widget within the career site (e.g., placed within a common header, footer, branding section, and so on, for pages provided by the career site 110, is shown as follows:

<script src=“http://platform.linkedin.com/in.js” type=“text/javascript”>
api_key: YOUR_API_KEY
</script>
<script type=“IN/CsapBeacon” data-contractid=“1011”
data-urlparserkey=“ats=jobvite&v=2.5” data-extra=“activity=apply”>
</script>

Following the example, when a page provided by the career site 110 is viewed by a user, the beacon 115 transmits a request to an API or URL associated with the career site analytics system 150, such as to an API or URL provided by the and/or in communication with the viewing information module 210. The transmitted request may include some or all of the information described herein, such as data defined as follows:

<url alias=“cws-csap-beacon” path=“/csap/beacon”>
<parameter alias=“contractId” urlName=“contractId”/>
<parameter alias=“urlParserKey” urlName=“urlParserKey”/>
<parameter alias=“url” urlName=“url”/>
<parameter alias=“referrer” urlName=“referrer”/>
<parameter alias=“topUrl” urlName=“topUrl”/>
<parameter alias=“topReferrer” urlName=“topReferrer”/>
<parameter alias=“extra” urlName=“extra”/>
</url>

For requests received from the beacon 115, the career site analytics system 150 records a tracking event, including information associated with the received request. Thus, the viewing information module 210 may access a data structure that stores the tracking events, such as a data structure that relates tracking events, and associated information) to career sites 110, among other things.

In some example embodiments, the social network module 220 is configured and/or programmed to determine users associated with the multiple viewing sessions are members of a social network service, and access profile information for users that are members of the social network service.

For example, the social network module 220 may compare and/or match a member ID within the information associated with one or more tracking events associated with a viewer of pages of the career site 110, and matches the member ID to a member ID associated with a member of the social network service 130 (and thus, determining the viewer is the member of the social network service 130 associated with the matching member ID).

Once the viewer is determined to be a member of the social network service 130, the social network module 130, in some example embodiments, accesses member profile information for the viewer/member. For example, the social network module 130 may access and/or receive biographical information (e.g., location information), demographic information (e.g., work experience and other career information, educational information, skills information, job status information, and so on), social graph information (e.g., information identifying the viewer/member's connections), behavior information (e.g., actions performed by the member within the social network service 130) and/or other attributes or information for the viewer/member.

In some example embodiments, the presentation module 230 is configured and/or programmed to present information identifying characteristics of the users associated with the multiple user viewing sessions based on accessed profile information. For example, the presentation module 230 may generate, display, and/or present (or, cause to be presented or displayed) a report or other display of information that provides insight about the viewership of pages provided by the career site 110.

The presentation module 230 may present various reports or displays of information. Example reports may include:

Reports that present a ranked list of referral sites associated with users associated with the multiple viewing sessions of the career site;

Reports that present a ranked list of user types assigned to users associated with the multiple viewing sessions of the career site;

Reports that present information associated with characteristics for users associated with the multiple viewing sessions of the career site, such as characteristics associated with work experiences for the users, characteristics associated with educational experiences for the users, characteristics associated with biographical information or demographic information for the users;

Reports that present information associated with a total number of users that entered the career site and a total number of users that submitted a job application via the career site;

Reports that present information associated with a total number of users that viewed a job listing presented by the career site and a total number of users that submitted a job application for a job represented by the job listing via the career site;

Reports that present information associated with top viewers or top referring sites, such as information identifying a number or type of viewers assigned a viewer score that represents an ideal or desired viewer (e.g., a viewer having previous CTO experience that views a job listing for a CTO would be assigned a high score and/or be considered a top viewer); and other reports or displayed information.

In some example embodiments, the presentation module 230 may present a user interface that includes one or more user-selectable elements that, when selected, cause the user interface to present a filtered view of information associated with viewership of the career site. For example, the presentation module 230 may present various user-navigable or customizable reports, enabling a user viewing the report to drill down on certain types of information for a career site 110, among other things.

Thus, in some example embodiments, the career site analytics system 150 includes modules that capture and/or access information associated with the viewing of pages provided by a career site 110, determine who the users are that are viewing the pages, and generate reports that provide insight into the viewership of the pages of the career site 110, among other things.

Examples of Capturing and/or Presenting Viewership Information for a Career Site

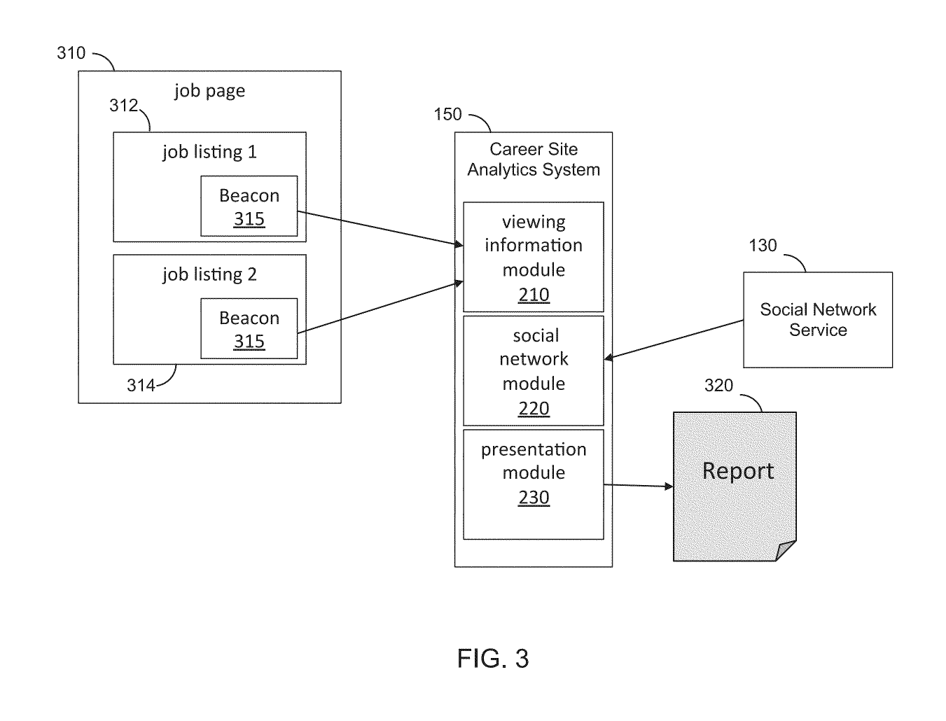

As described herein, the career site analytics system 150 may generate reports associated with the viewership of pages provided by the career site 110, among other things. For example, FIG. 3 is a block diagram illustrating data flow operations between the career site 110, the social network service 130, and the career site analytics system 150, consistent with some embodiments.

A job page 310 provided by the career site 110 displays two job listings, such as job listing 312 and job listing 314. The job page 310 also includes a javascript beacon 315 (e.g., a snipped of javascript code) that is located in the header/footer of the source code for the job listings). During a viewing session by a user of the page 310, the beacon captures information associated with the viewing session (member ID for viewer, URL for referring site, URL for viewed page, and so on), and transmits the captured information as a request to the viewing information module 210 of the career site analytics system 150.

Using the received member ID, the social network module 220 communicates with the social network service 130 and extracts member profile information associated with a member having a matching member ID. The presentation module 230 utilizes information captured by the beacons 315 and accessed by the viewing information module 210, as well as the member profile information accessed by the social network module 220, and generates and/or presents various reports associated with the viewership of the job page 310.

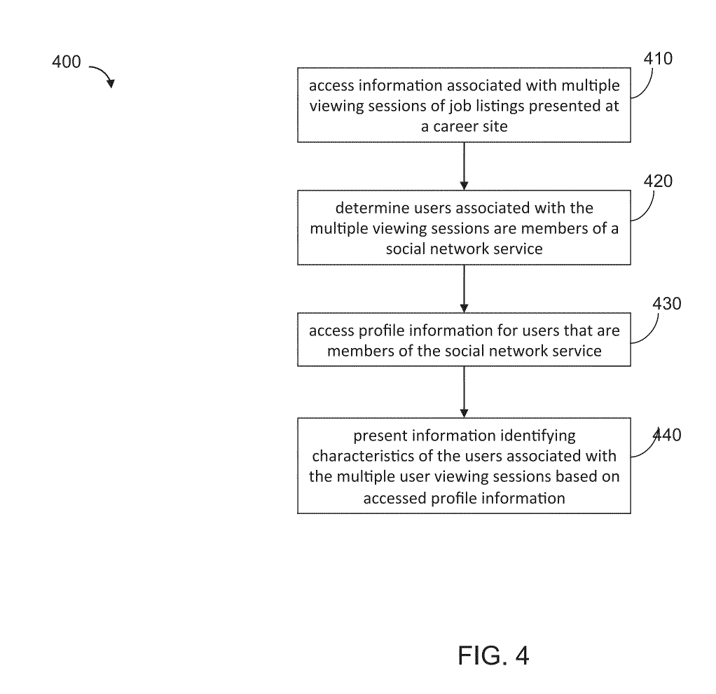

FIG. 4 is a flow diagram illustrating a method 400 for presenting viewership information associated with viewers of a career site, consistent with some embodiments. The method 400 may be performed by the career site analytics system 150 and, accordingly, is described herein merely by way of reference thereto. It will be appreciated that the method 400 may be performed on any suitable hardware.

In operation 410, the career site analytics system 150 accesses information associated with multiple viewing sessions of job listings presented at a career site. For example, the viewing information module 210 may access information captured by the javascript beacon 115 located at a page provided by and/or supported by the career site 110 (e.g., supported by an ATS), such as a job listing page that includes job listings presented at the career site 110 or a job application page configured to facilitate applications for jobs by viewers of the career site 110. As described herein, the captured information may include information associated with a referring site, information associated with a user viewing the pages of the career site 110, and/or other information described herein.

In operation 420, the career site analytics system 150 determines users associated with the multiple viewing sessions are members of a social network service. For example, the social network module 220 may compare and/or match a member ID within the information associated with one or more tracking events associated with a viewer of pages of the career site 110, and matches the member ID to a member ID associated with a member of the social network service 130 (and thus, determining the viewer is the member of the social network service 130 associated with the matching member ID).

In operation 430, the career site analytics system 150 accesses profile information for users that are members of the social network service. For example, the social network module 130 may access and/or receive biographical information (e.g., location information), demographic information (e.g., work experience and other career information, educational information, skills information, job status information, and so on), social graph information (e.g., information identifying the viewer/member's connections), behavior information (e.g., actions performed by the member within the social network service 130) and/or other attributes or information for the viewer/member.

In operation 440, the career site analytics system 150 presents information identifying characteristics of the users associated with the multiple user viewing sessions based on accessed profile information. For example, the presentation module 230 may generate, display, and/or present (or, cause to be presented or displayed) a report or other display of information that provides insight about the viewership of pages provided by the career site 110, such as the various reports described herein.

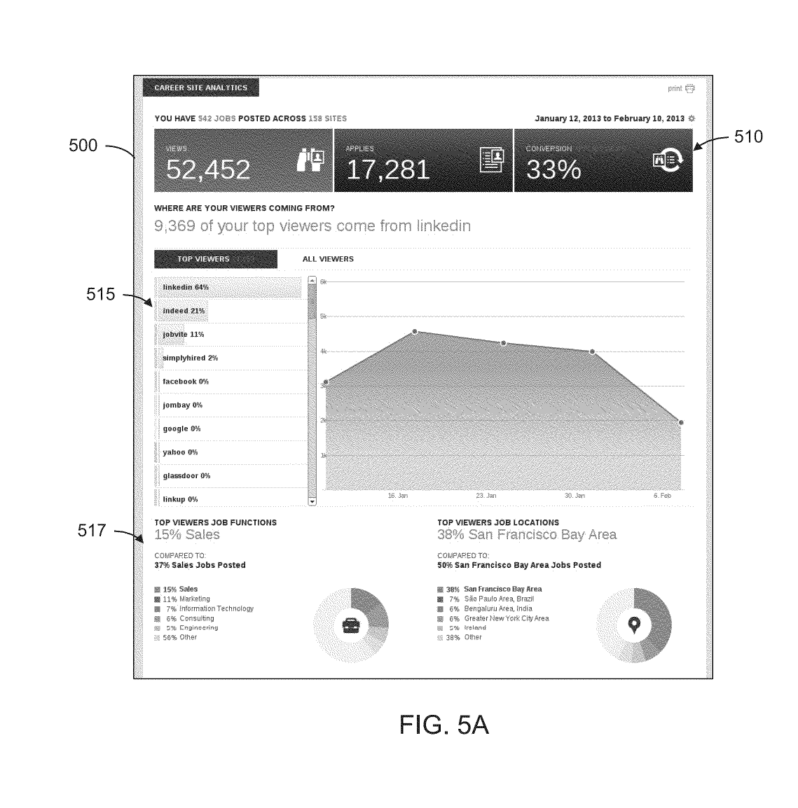

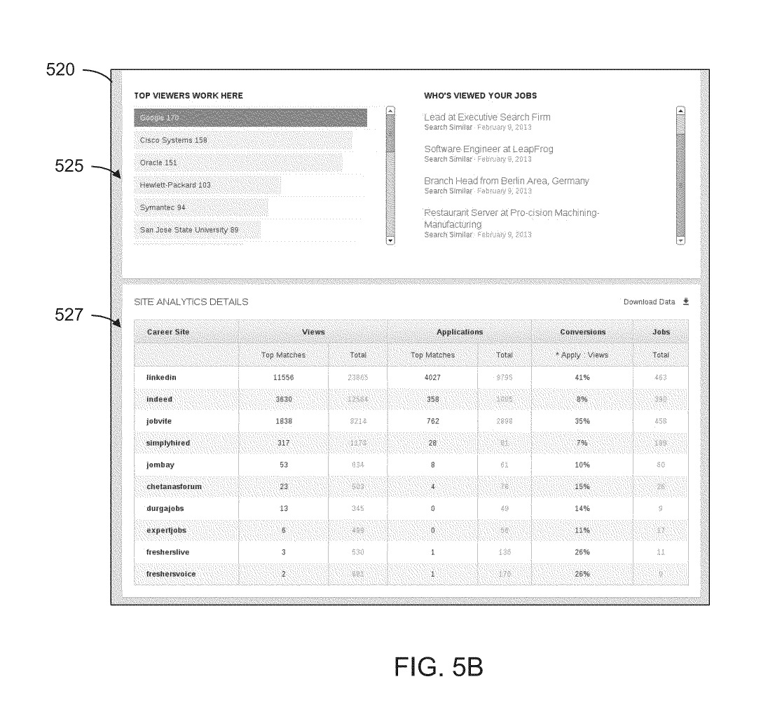

As described herein, the presentation module 230 may present various different information and/or reports, such as the information and/or reports described herein. FIGS. 5A-5B are display diagrams illustrating the presentation of viewership information for a career site, consistent with some embodiments.

FIG. 5A depicts a user interface 500 presenting a report of the viewership of a career site that includes numerous pages of job listings. The user interface 500 presents various captured and/or determined information associated with the viewership of the career site. For example, the user interface 500 presents information 510 identifying viewing metrics (e.g., a number of views, a number of applicants, and a rate of conversion between views and applications). The user interface also presents information 515 displaying a ranked list of the top referring sites, and information 517 displaying the types of users who viewed the job listings of the career site.

FIG. 5B depicts a user interface 520 presenting additional viewership information for the career site. The report includes information 525 identifying the employers of the top viewers of pages of the career site, and information 527 providing detailed viewership information for various referring sites that sent users to the career site.

Of course, the user interfaces 500 and 520 may present other information not shown in the Figures.

Thus, in some example embodiments, the career site analytics system 150 may capture various viewership information for a career site, identify information associated with the viewers of the career site, and generate reports and other information displays based on analyses of the information, among other things.

For example, the career site analytics system 150 may access information captured by a javascript beacon located at a job listing page provided by a career site, the information associated with user viewership of the job listing page provided by the career site, identify one or more referral sites that referred users to the career site based on the accessed information, and present information comparing the identified one or more referral sites.

Examples of Capturing Information from Multiple Pages of a Career Site

As described herein, the career site analysis system 150 may provide, generate, and/or utilize javascript beacons 115 located at career sites (e.g., embedded or hidden in pages of the career site 110) in order to capture viewing information for the career sites, among other things. In some example embodiments, the career site analysis system 150 may provide multiple beacons 115 and/or other mechanisms in order to capture viewing information for multiple pages provided by the career sites.

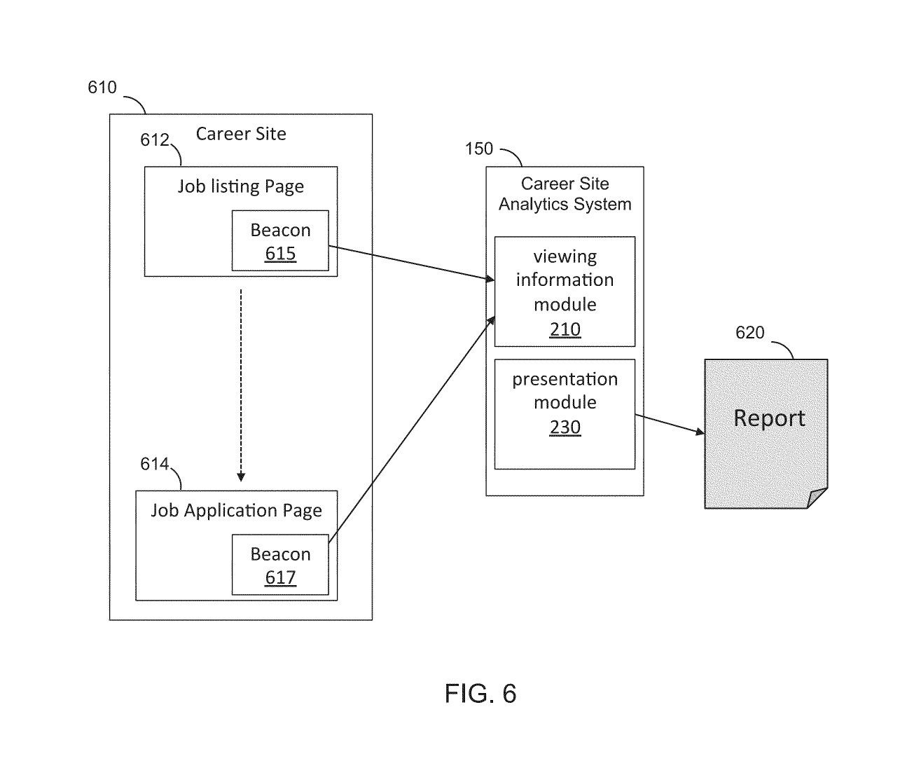

FIG. 6 is a block diagram illustrating data flow operations between various pages of a career site 610 and the career site analytics system 150, consistent with some embodiments. The career site 610 provides multiple pages, including a job listing page 612 and a job application page 614. The job listing page 612 includes a javascript beacon 615 and the job application page 614 includes a javascript beacon 617. When the job listing page 612 is viewed, the beacon 615 captures information associated with the viewing session (member ID for viewer, URL for referring site, URL for viewed page, and so on), and when the job application page 614 is viewed, the beacon 617 captures information associated with the viewing session (member ID for viewer, URL for referring site, URL for viewed page, and so on). The beacons 615 and 617 transmit the captured information as requests to the viewing information module 210 of the career site analytics system 150.

The presentation module 230 utilizes the information captured by the beacons 615 and 617 and accessed by the viewing information module 210, performs a comparison of the information, such as a comparison of member IDs for viewers of the job listing page 612 to member IDs for viewers of the job application page 614, and presents information determined from the comparison, such as a report 620 that presents information associated with the viewership at both pages.

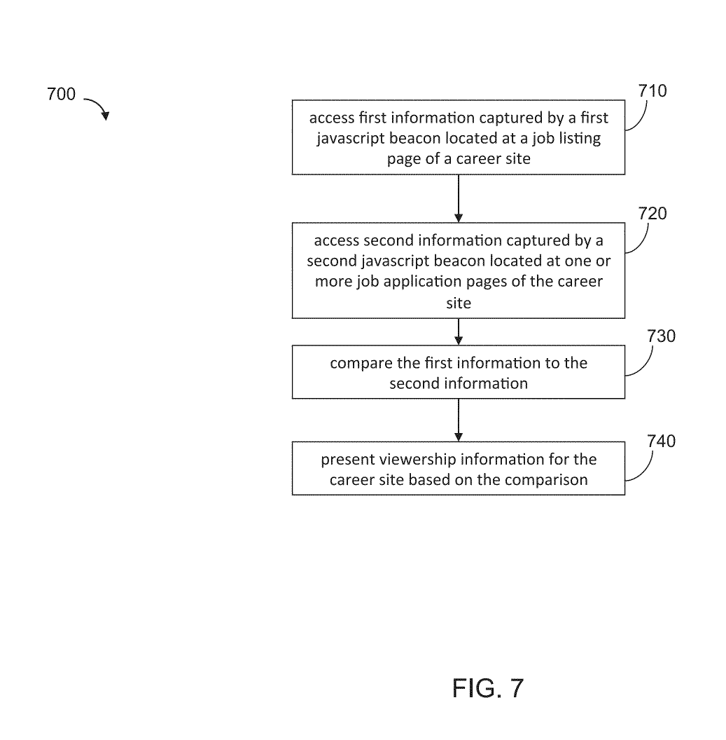

FIG. 7 is a flow diagram illustrating a method 700 for presenting viewership information for various pages of a career site, consistent with some embodiments. The method 700 may be performed by the career site analytics system 150 and, accordingly, is described herein merely by way of reference thereto. It will be appreciated that the method 700 may be performed on any suitable hardware.

In operation 710, the career site analytics system 150 accesses first information captured by a first javascript beacon located at a job listing page of a career site. In operation 720, the career site analytics system 150 accesses second information captured by a second javascript beacon located at one or more job application pages of the career site. For example, the viewing information module 210 may access information captured by the beacons 615 and/or 617, such as information associated with a referring site for a viewer of the pages 612 and/or 614, information associated with a user (e.g., a member ID or device ID) viewing the pages 612 and/or 614, and/or other information described herein.

In operation 730, career site analytics system 150 compares the first information to the second information. For example, the presentation module 230 may perform an analysis of the accessed information to identify and/or determine at what pages the users entered and/or exited the career site 110.

In operation 740, the career site analytics system 150 presents viewership information for the career site based on the comparison. For example, the presentation module 230 may generate, display, and/or present (or, cause to be presented or displayed) a report or other display of information that provides insight about the viewership of pages provided by the career site 110, such as the various reports described herein.

The presented reports may include information identifying and/or associated with various paths of page views through the career site 110 by users/viewers, including viewership information that reflects a determined percentage of viewers of the job listing page that submit job applications via the one or more job application pages, a list of referral sites ranked based on viewership numbers of users referred to the career site, a list of referral sites ranked based on a number of users referred to the career site that submit job applications to the career site, information associated with referral sites that referred the users to the career site, information associated with an entry page provided by the career site at which the users entered the career site, information associated with an exit page provided by the career site from which the users exited the career site, and so on.

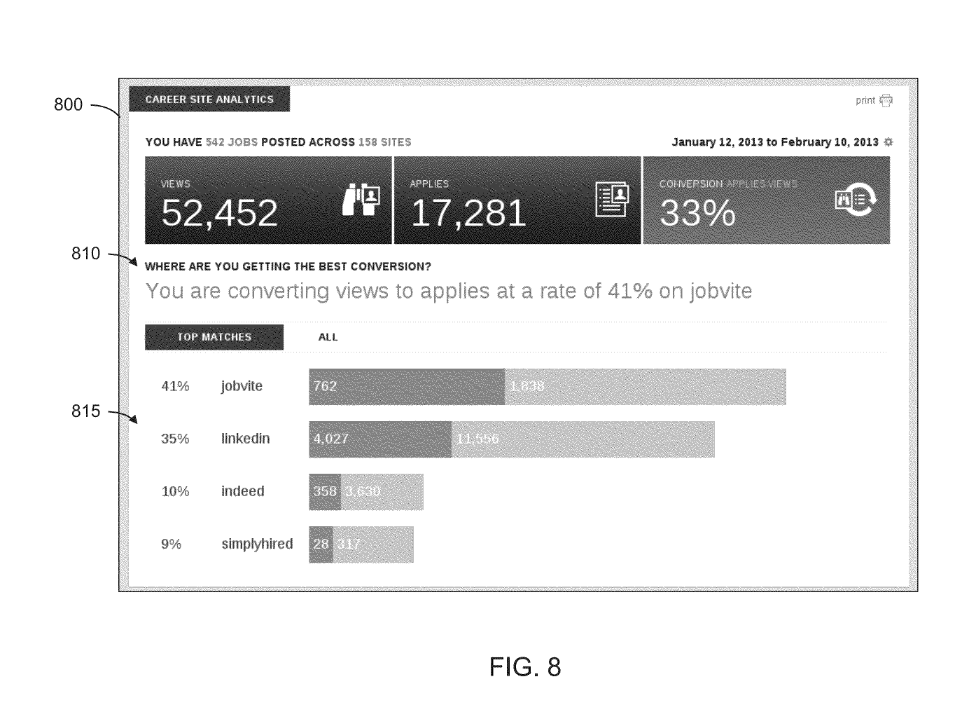

For example, FIG. 8 is a display diagram illustrating the presentation 800 of viewership information for various pages of a career site, consistent with some embodiments. A user interface 800 presents information 810 identifying viewing metrics (e.g., a number of views, a number of applicants, and a rate of conversion between views and applications), along with analysis information 810 and detailed information 815 associated with conversion rates for referring sites.

In some example embodiments, when the accessed first information and the accessed second information includes member identification information associated with a viewer of the career site that is a member of a social network service, the career site analytics system 150 may access, via the social network module 220, member profile information from the social network service 130 for a viewer or viewers, and present viewer demographic information along with other presented viewership information.

In some cases, the career site 110 (e.g., the ATS) may only support and/or authorize use of a single beacon 115, such as a beacon placed and/or located at a job listing page or other entry page for the career site 110. In these cases, the career site analytics system 150 may facilitate the capture of viewership information from additional pages provided by the career site 110, such as other job listing pages, intermediate pages, job application pages and other exit pages (e.g., a page displaying a message of a successful completion of a job application submission), and so on.

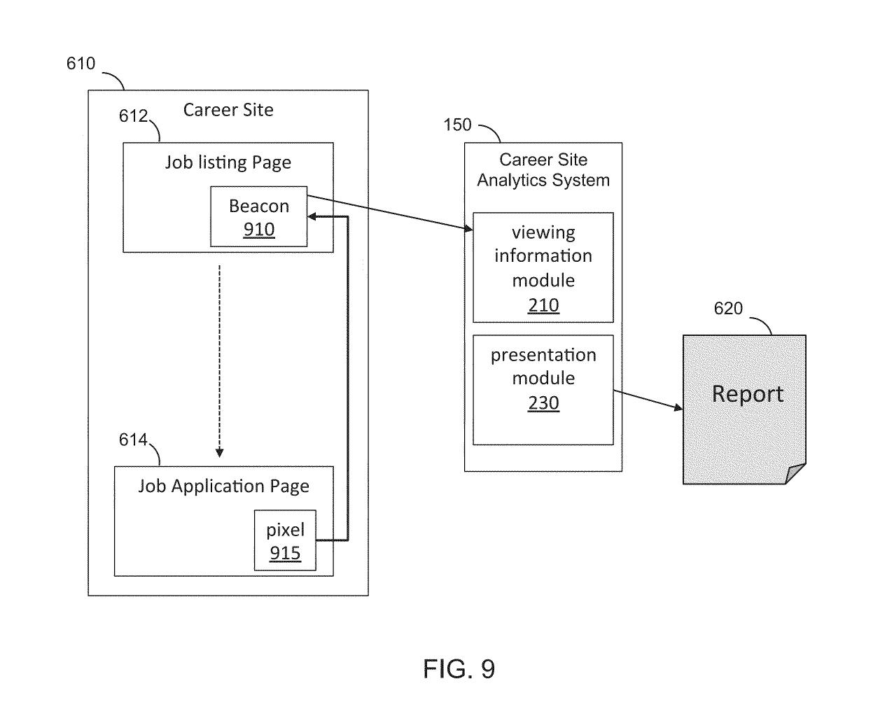

FIG. 9 is a block diagram illustrating data flow operations between a information capture beacon and one or more tracking pixels within a career site, consistent with some embodiments. The career site 610 provides multiple pages, including a job listing page 612 and a job application page 614. The job listing page 612 includes a javascript beacon 910 and the job application page 614 includes a tracking pixel 915. A tracking pixel 915 is a javascript tag (or, another tag, such as an HTML img tag) embedded in a page provided by the career site 110 that sends information for every view of the page to the beacon 910. The beacon then tracks views of other pages provided by the career site 110 based on information received from tracking pixels 915 embedded in the pages.

For example the job listing page 612 is viewed, the beacon 910 captures information associated with the viewing session (member ID for viewer, URL for referring site, URL for viewed page, and so on), and when the job application page 614 is viewed, the tracking pixel 915 sends the beacon 910 an indication of the view event, and the beacon 915 captures information associated with the viewing session (member ID for viewer, URL for referring site, URL for viewed page, and so on) received from the tracking pixel. The beacon 910 transmits the captured information as requests to the viewing information module 210 of the career site analytics system 150.

The presentation module 230 utilizes the information captured by the beacon 910 and accessed by the viewing information module 210, performs a comparison of the information, such as a comparison of member IDs for viewers of the job listing page 612 to member IDs for viewers of the job application page 614, and presents information determined from the comparison, such as a report 620 that presents information associated with the viewership at both pages.

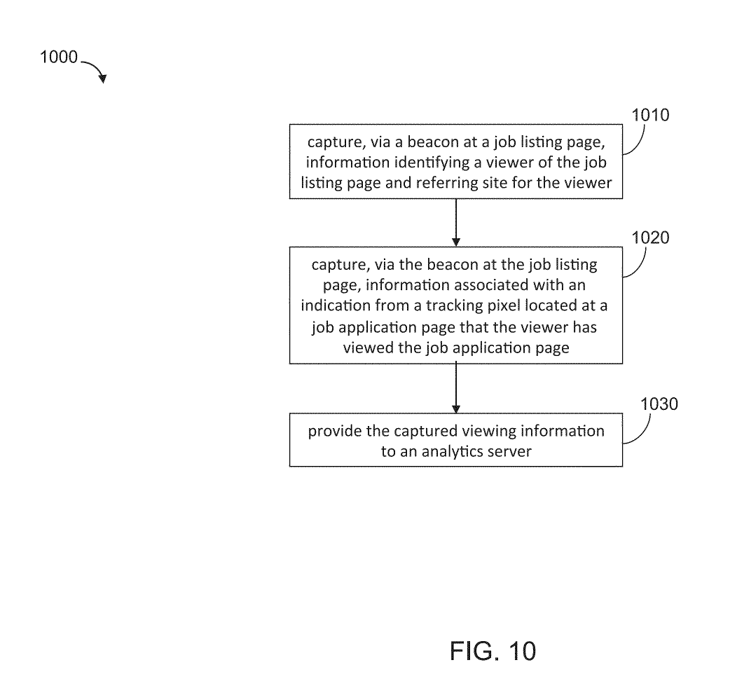

FIG. 10 is a flow diagram illustrating a method 100 for providing information associated with viewership of various pages of a career site, consistent with some embodiments. The method 1000 may be performed by the beacon 910 and, accordingly, is described herein merely by way of reference thereto. It will be appreciated that the method 1000 may be performed on any suitable hardware.

In operation 1010, the beacon 910 captures information identifying a viewer of the job listing page and information identifying a referring site for the viewer. In operation 1020, the beacon 910 captures information from a tracking pixel located at a job application page, the information indicating the viewer has viewed the job application page. For example, the tracking pixel 915 may transmit to the beacon 910 an indication of a tracking event associated with a viewer submitting a job application via the job application page and/or viewing one or more job application pages.

In operation 1030, the beacon 910 provides the captured information to an analytics server, such as a server supporting the career site analytics system 150. For example, the beacon 910 may provide the captured information to the career site analytics system 150 that is configured to generate a report that presents viewership information associated with a career site that provides the job listing page and the job application page.

Thus, in some example embodiments, the career site analytics system 150 captures viewership information for some or all job and recruitments pages provided by the career site 150, enabling the system 150 to provide an entity associated with the career site 150 with various viewership data analytics, metrics, and other information.

Some example embodiments of the technology, therefore, enable an employment site to receive application submissions on behalf of job candidates based on information obtained from social networking sites that include the job candidates as members, among other benefits.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules, engines, objects or devices that operate to perform one or more operations or functions. The modules, engines, objects and devices referred to herein may, in some example embodiments, comprise processor-implemented modules, engines, objects and/or devices.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

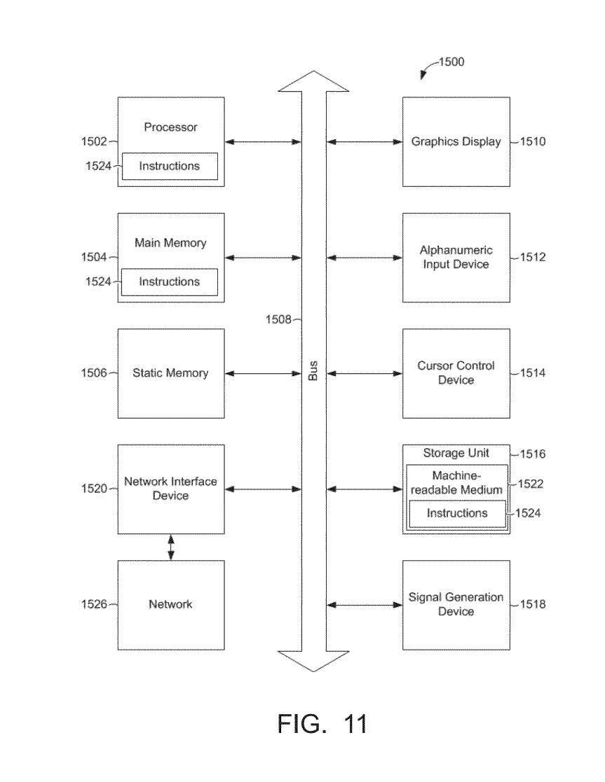

FIG. 11 is a block diagram of a machine in the form of a computer system or computing device within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. In some embodiments, the machine will be a desktop computer, or server computer, however, in alternative embodiments, the machine may be a tablet computer, a mobile phone, a personal digital assistant, a personal audio or video player, a global positioning device, a set-top box, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A method, comprising:
accessing, via a network interface, first information captured by a first javascript beacon located at a job listing page of a career site, the job listing corresponding to a unique job identifier and the career site corresponding to a unique career site identifier;
accessing, via the network interface, second information captured by a second javascript beacon located at one or more job application pages of the career site;
comparing, by a processor of a career site analytics system of a server computer, the first information to the second information to determine the percentage of viewers of the job listing page that submit job applications via the one or more job application pages of the career site;
presenting, via a user interface, based on the job identifier and the career site identifier, viewership information for the career site based on the comparison including information that reflects the determined percentage of viewers of the job listing page that submit job applications via the one or more job application pages.

2. The method of claim 1, wherein the accessed first information and the accessed second information includes member identification information associated with a viewer of the career site that is a member of a social network service, the method further comprising:
accessing member profile information from the social network service for the viewer; and
presenting viewer demographic information along with the presented viewership information.

3. The method of claim 1, wherein the accessed first information and the accessed second information includes member identification information associated with a viewer of the career site that is a member of a social network service.

4. The method of claim 1, wherein the accessed first information and the accessed second information includes an IP address or device identifier for a device associated with a viewer of the career site that presented the job listing page of the career site to the viewer.

5. (canceled)

6. The method of claim 1, wherein the accessed first information and the accessed second information includes information associated with referral sites that referred users to the career site; and wherein presenting viewership information for the career site based on the comparison includes presenting a list of referral sites that is ranked based on viewership numbers of users referred to the career site.

7. The method of claim 1, wherein the accessed first information and the accessed second information includes information associated with referral sites that referred users to the career site; and wherein presenting viewership information for the career site based on the comparison includes presenting a list of referral sites that is ranked based on a number of users referred to the career site that submit job applications to the career site.

8. The method of claim 1, wherein the accessed first information and the accessed second information includes information associated with referral sites that referred users to the career site; and wherein presenting viewership information for the career site based on the comparison includes presenting information associated with referral sites that referred the users to the career site, information associated with an entry page provided by the career site at which the users entered the career site, and information associated with an exit page provided by the career site from which the users exited the career site.

9. A system, comprising:
a processor;
a memory for storing executable instructions representing modules, the modules including:
a hardware-implemented viewing information module that is configured to access first information captured by a first javascript beacon located at a job listing page of a career site and access second information captured by a second javascript beacon located at one or more job application pages of the career site, the job listing corresponding to a unique job identifier and the career site corresponding to a unique career site identifier; and
a hardware-implemented presentation module that is configured to present, based on the job identifier and the career site identifier, viewership information for the career site based on a comparison of the first information with the second information, the viewership information including information that reflects a determined percentage of viewers of the job listing page that submit job applications via the one or more job application pages.

10. The system of claim 9, wherein the accessed first information and the accessed second information includes member identification information associated with a viewer of the career site that is a member of a social network service, the system further comprising:
a social network module that is configured to access member profile information from the social network service for the viewer;
wherein the presentation module is configured to present viewer demographic information along with the presented viewership information.

11. The system of claim 9, wherein the accessed first information and the accessed second information includes member identification information associated with a viewer of the career site that is a member of a social network service.

12. The system of claim 9, wherein the accessed first information and the accessed second information includes an IP address or device identifier for a device associated with a viewer of the career site that presented the job listing page of the career site to the viewer.

13. (canceled)

14. The system of claim 9, wherein the accessed first information and the accessed second information includes information associated with referral sites that referred users to the career site; and wherein the presentation module is configured to present a list of referral sites that is ranked based on viewership numbers of users referred to the career site.

15. The system of claim 9, wherein the accessed first information and the accessed second information includes information associated with referral sites that referred users to the career site; and wherein the presentation module is configured to present a list of referral sites that is ranked based on a number of users referred to the career site that submit job applications to the career site.

16. The system of claim 9, wherein the accessed first information and the accessed second information includes information associated with referral sites that referred users to the career site; and wherein the presentation module is configured to present information associated with referral sites that referred the users to the career site, information associated with an entry page provided by the career site at which the users entered the career site, and information associated with an exit page provided by the career site from which the users exited the career site.

17. A non-transitory computer-readable storage medium whose contents, when executed by a computing system, cause the computing system to perform operations, comprising:
capturing, via a beacon at a job listing page, information identifying a viewer of the job listing page and information identifying a referring site for the viewer, the job listing corresponding to a unique job identifier and the career site corresponding to a unique career site identifier;
capturing, via the beacon at the job listing page, information from a tracking pixel located at a job application page, the information indicating the viewer has viewed the job application page; and
providing the captured information to an analytics server so as to enable the analytics server to provide viewership information based on the job identifier and the career site identifier, including information that reflects a determined percentage of viewers of the job listing page that submit job applications via the application page.

18. The computer-readable storage medium of claim 17, wherein providing the captured information to an analytics server includes providing the captured information to a career site analytics system configured to generate a report that presents viewership information associated with a career site that provides the job listing page and the job application page.

19. The computer-readable storage medium of claim 17, wherein capturing information from a tracking pixel located at a job application page includes capturing information associated with a recording of a tracking event of the viewer submitting a job application via the job application page.

20. The computer-readable medium of claim 17, wherein an applicant tracking service provides the job listing page and supports the beacon.
